(19) United States
(12) Patent Application Publication
(10) Pub. No.: US 2006/0230000 A1
(43) Pub. Date: Oct. 12, 2006

(54) Smart return address indicium and method of use

(76) Inventor: Karl S. Lubinger, Endwell, NY (US)

Correspondence Address: MILES & STOCKBRIDGE PC, 1751 PINNACLE DRIVE, SUITE 500, MCLEAN, VA, 22102-3833, US

(21) Appl. No.: 11/100,380

(22) Filed: Apr. 7, 2005

(51) Int. Cl. G01G 19/413

(52) U.S. Cl. 705/407

(57) ABSTRACT

A method including determining a weight for a mail piece, calculating a delivery cost for the mail piece to an addressee identified on the mail piece, and determining a return address indicium for a sender is on the mail piece. The method also including determining an account is associated with the sender from the return address indicium, deducting the delivery cost from the account of the sender, associating a delivery cost paid indication with the mail piece, and forwarding the mail piece for delivery to the addressee.

### BRIEF DESCRIPTION OF THE DRAWINGS

The present invention will be described with reference to the accompanying drawings.

FIG. 1 is an example of a return address postal indicium containing both bar-coded and human-readable information that may be used in accordance with embodiments of the present invention.

FIG. 2 is another example of a return address postal indicium containing both bar-coded and human-readable information that may be used in accordance with other embodiments of the present invention.

FIG. 3 is a block diagram of a mail piece having affixed thereto a return address postal indicium, in accordance with an embodiment of the present invention.

FIG. 4 is a flow diagram of a method for using a return address postal indicium, in accordance with an embodiment of the present invention.

FIG. 5 is a flow diagram of an overall method for using a return address postal indicium, in accordance with an embodiment of the present invention.

FIG. 6 is a block diagram of a system to print return address postal indicia, in accordance with another embodiment of the present invention.

FIG. 7 is a flow diagram of a method for printing and using a return address postal indicium, in accordance with an embodiment of the present invention.

FIG. 8 is a flow diagram of a method for printing and using a return address postal indicium, in accordance with another embodiment of the present invention.

### DETAILED DESCRIPTION

In accordance with an embodiment of the present invention, a method and product for paying postage for mail pieces without the use of separate postal indicium (e.g., a postage stamp). Specifically, the method and product may integrate data necessary to process mail to include sender information in a single identification mechanism to replace current forms of postage, e.g., stamps, metered postage marks, an/or online postage indicia. “Mail” as used herein may apply to mail items (e.g., letters, packages, etc.) that are sent via a public/private postal service as well as mail items sent via non-postal delivery service providers. “Mail items” may include letters, packages, parcels, boxes, and the like of all shapes and sizes.

In accordance with an embodiment of the present invention, a return address indicium to be applied to a mail piece may include all sender and postage fee payment information necessary for the mail piece to be mailed to an addressee identified in an addressee block on the mail piece. The return address indicium may include a human-readable portion and a machine-readable portion, which may also include payment or account information to be used to charge for the mail piece to which the return address indicium may be attached. The general concept is similar to a pre-paid toll system in which users/customers register with a toll authority/authorities to establish a payment account, e.g., the EZpass system used along portions of the East Coast. For example, the payment account may be established with a return address indicium service provider and/or a delivery service provider, which may be the same or different entities that may each provide one or both services. The payment account may be established as a pre-paid account with advance payments made by check, cash, money order, credit card, or the like or a guaranteed account using a credit card and/or direct debit card or some other account, e.g., checking, savings, money market, etc. Once the account is established, the user may receive the necessary electronic information, for example, an electronic (i.e., digital) indicium and associated software, to be able to print his/her own return address postal indicia either directly on mail pieces or on labels for separately affixing them to mail pieces. Alternatively, the user may request that the return address indicium service provider and/or the delivery service provider, i.e., postal and/or non-postal, provide pre-printed return address labels with the necessary return address and account information. As a result, postal indicia, i.e., stamp and the like, are no longer needed, since the correct amount may be charged for each mail piece based on the actual weight measured by the delivery service provider. The user may check activity and/or a balance in the account via the Internet, over the phone and/or in person at the delivery service provider.

Although, the information in the return address indicium may appear in both human-readable and machine-readable formats, e.g., text and barcodes, respectively, reading the information from the return address indicium may be accomplished using automated equipment. For example, the barcode may be printed both with and without the human-readable information, and any human-readable information printed with the barcode may also be coded in the barcode. However, the payment and/or account information used in embodiments of the present invention, in general, may only be printed in the barcode for security reasons. Regardless, the entire return address indicium may be read (e.g., a bit-mapped image of the human-readable portion may be made and the image may be converted to actual digital character values; and the barcode may be scanned and the pattern converted to represent digital character values of information encoded in the barcode). To convert the bit-mapped image to actual digital character values may require an optical character recognition (“OCR”) program be run that may determine the value of each character of the human-readable portion and save it as such. In general, the entire return address indicium may be read (e.g., scanned) at a mail processing facility in a single scan of a mail piece on which the return address indicium is affixed, scanned, and deciphered and the deciphered return address indicium information may be sent to a system to determine whether the account in the return address indicium is valid and has balance/credit level that is sufficient to pay for the mail piece to which the return address indicium is affixed.

In accordance with embodiments of the present invention, revenue protection features may include charging/collecting the correct amount of postage for each mail piece, thus, reducing the time and manpower needed to return a mail piece to the sender for insufficient postage or attempt to collect the missing postage from the addressee. In addition, use of the return address indicia may significantly reduce the need for delivery service provider mail piece intake personnel from having to weigh and affix postage to oversized letters and/or parcels. Similarly, the present invention may provide a positive cash flow to the delivery service provider, since the pre-paid accounts would provide upfront cash (like the purchasing of stamps does today), but without the attendant cost of having to print the stamps.

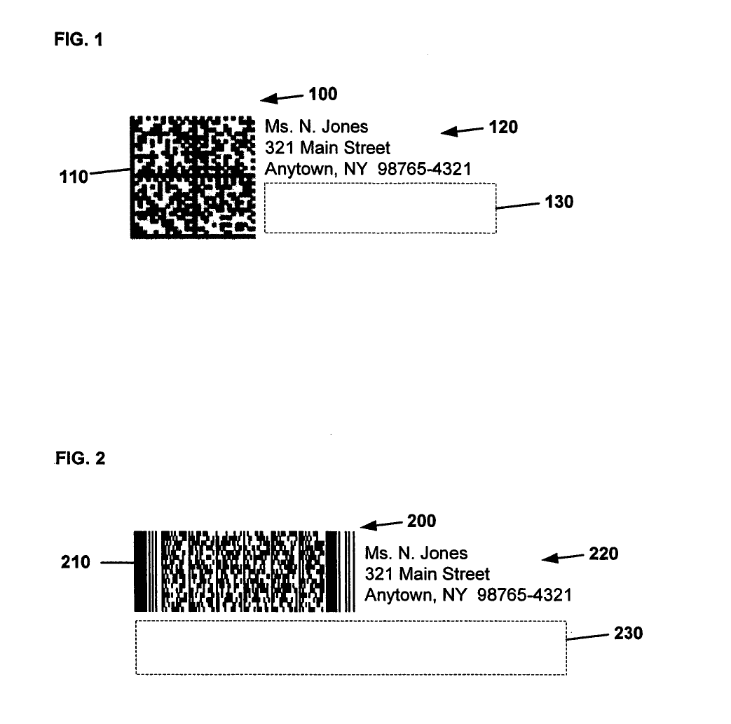

FIG. 1 is an example of a return address postal indicium containing both barcoded and human-readable information that may be used in accordance with embodiments of the present invention. In FIG. 1, a return address indicium 100 may include a bar-coded portion 110 and a human-readable portion 120, which, in general, only provides a sender's address, i.e., a return address. Bar-coded portion 110 may be implemented as a datamatrix bar code and/or any other bar code and although bar-coded portion 110 is shown to the left of human-readable portion, bar-coded portion 110 also may be located above, below and/or to the left of human-readable portion 120. Return address 100 may also include one or more optional, personalization portion 130. Although, in FIG. 1, personalization portion 130 is shown below human-readable portion 120 and to the right of bar-coded portion 110, it also may be located to the left, right, above and/or below bar-coded portion 110 and human-readable portion 120. Personalization portion 130 may be used to print personalized messages, company logos; pictures, graphics, advertisements, etc. In addition, personalization portion 130 may be used to include information on the type of mail piece, characteristics of the mail piece, recipient information; and/or class of service for which the return address indicium is to be used. For example, type may include letter, postcard, package, books, etc; characteristics may include dimensions, weight at mailing, packaging material, fragile, perishable, etc.; recipient information may include recipient's name and full or partial address information; and class may include first, second, third, etc.

In general, in FIG. 1, bar-coded portion 110 will have an account number associated with at least one sender at the sender's address and may have all of the sender's address information shown in human-readable portion 120. For example, a joint account may be associated with a husband and wife and the sender information line in the sender's address may read Mr. and Mrs. John Smith; Mr. John Smith; Ms. Nancy Smith; The Smiths; etc. It is also possible to have more than one account associated with the same address. For example, Mrs. Smith from the Smiths described above may have a business that she runs out of a home office and although the street and city address information may be the same as the Smith's personal residence, a separate account number may be associated with Mrs. Smith's business return address. Since, each account number is associated with a specific user and/or users address, if the sender's address is the same as the user address that can be determined from the account records, the sender's address may be omitted from bar-coded portion 110. However, it may also be the case that the account address and sender's address are not the same. Regardless, including the sender's address information in bar-coded portion 110 may aid in detecting fraud and/or counterfeiting.

In FIG. 1, bar-coded portion 10 also may include a serial number, which may be unique to each return address indicium 100 and may not be displayed in human-readable portion 120, to help prevent counterfeiting of return address indicium 100. For example, the serial number may be checked against at least one listing of serial numbers that may be associated with the sender's account to determine whether the serial number has been printed and/or previously used. In general, the listing of serial numbers may be located at a mail piece delivery service provider that supports the use of return address indicium. If the serial number has already been used, the return address indicium may be considered to be a duplicate, counterfeit, etc. and the mail piece to which the current return address indicium is attached may be diverted from being delivered.

Regardless of the type of bar-coded region, return address indicium 100 may be provided to a user/customer as an electronic indicium that may be printed as needed by the user/customer and/or may be printed directly onto labels by the delivery service provider, for example, the United States Postal Service (“USPS”) and/or any other delivery service provider, and provided to the user/customer. As a result, to prevent confusion and duplication of serial numbers, separate serial number sequences may be associated with the return address indicium printed by the delivery service provider and the user/customer. Since return address indicium may be printed by the user/customer using the electronic serial number indicium provided by the delivery service provider, the system used to print the indicium may assign and print unique serial numbers in each indicium. In addition, this information may be transmitted to the delivery service provider to be associated with the sender's account and used to check each return address indicium presented to the delivery service provider. For example, the information sent to the delivery service provider may be as simple as the last serial number printed in an ascending sequence to a listing of randomly assigned and printed serial numbers.

FIG. 2 is another example of a return address postal indicium containing both bar-coded and human-readable information that may be used in accordance with other embodiments of the present invention. As in FIG. 1, in FIG. 2, a return address indicium 200 may include a bar-coded portion 210 and a human-readable portion 220, which, in general, only provides a sender's address, i.e., a return address. Bar-coded portion 210 may be implemented as a PDF 417 bar code and/or any other bar code and although bar-coded portion 210 is shown to the left of human-readable portion, bar-coded portion 110 also may be located above, below and/or to the left of human-readable portion 220. Return address 200 may also include one or more optional, personalization portion 230. Although, in FIG. 2, personalization portion 230 is shown below human-readable portion 220 and bar-coded portion 210, it also may be located to the left, right, above and/or below bar-coded portion 210 and human-readable portion 220. Personalization portions 230 may be used to print personalized messages, company logos, pictures, graphics, advertisements, etc. Just as described above for FIG. 1, in FIG. 2, personalization portion 230 may be used to include information on the type of mail piece and or class of service for which the return address indicium is to be used. For example, type may include letter, postcard, package, books, etc. and class may include first, second, third, etc. In general, bar-coded portion 210 will have all of the sender's address information shown in human-readable portion 220 as well as an account number and a unique serial number associated with at least one sender at the sender's address, similar to that described above in relation to FIG. 1.

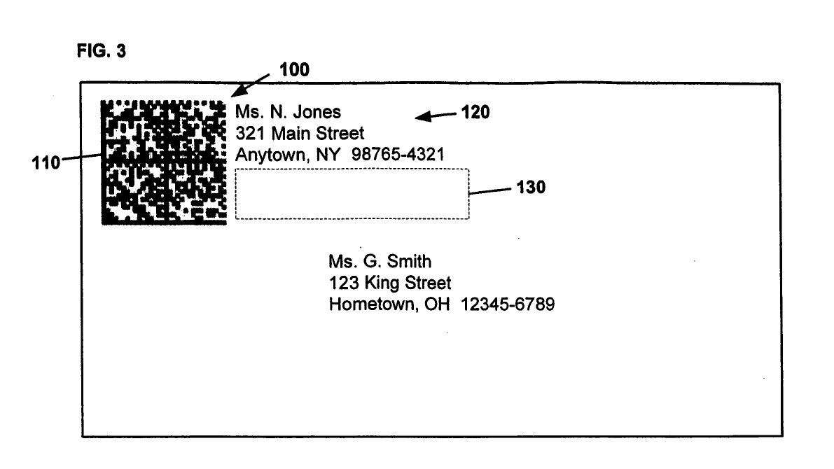

FIG. 3 is a block diagram of a mail piece having affixed thereto a return address postal indicium, in accordance with an embodiment of the present invention. In FIG. 3, a return address postal indicium 300 may be affixed to a mail piece 305 in the upper left hand corner of a front face of mail piece 305. Return address postal indicium 300 may include a datamatrix bar code portion 310 and a human-readable portion 320 similar to that shown and described above in FIG. 1. In FIG. 3, although return address postal indicium 300 is shown located in the upper left hand corner of the front face of mail piece 305, it may be located anywhere on the front face or any where else on mail piece 305 that may be imaged by automatic mail piece processing equipment. It should be noted that mail piece 305 does not have a stamp and/or other postage stamp indicium applied to the front of mail piece 305, since one is not needed with return address postal indicium in embodiments of the present invention.

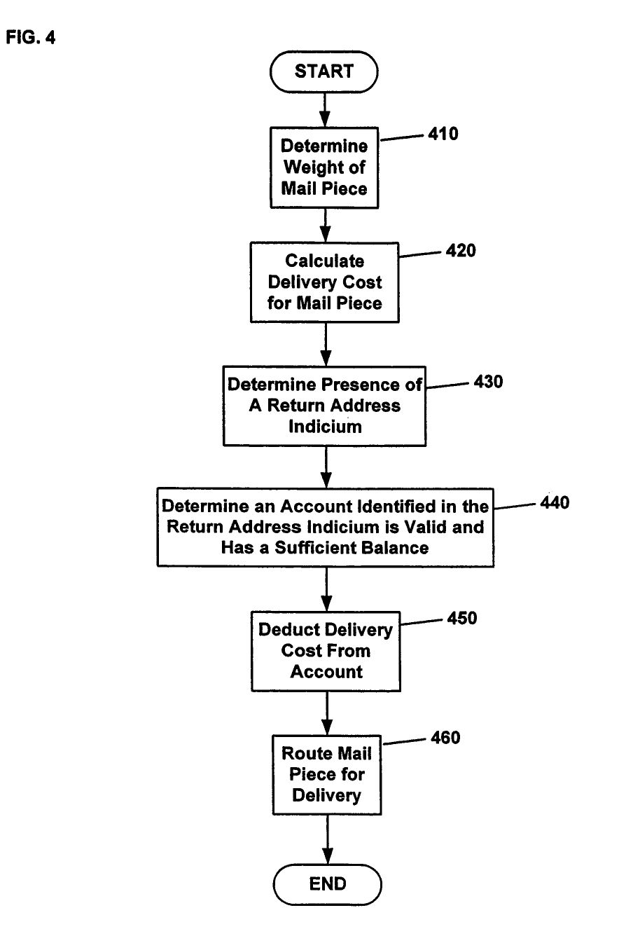

FIG. 4 is a flow diagram of a method for using a return address postal indicium, in accordance with an embodiment of the present invention. In FIG. 4, the method may include determining (410) a weight for a mail piece, for example, on a mail processing/sorting system such as mail and/or package processing systems. The method also may include calculating (420) a cost for delivering the mail piece to an addressee identified on the mail piece. For example, this calculation may be based on the weight of the mail piece, a type of the mail piece (e.g., letter, package, etc.), and a class of service (e.g., first, second, air mail, land, international, etc.). The class of service may be predefined in the return address indicium and/or may be determined based at least on the type of mail piece and logic and/or one or more rules associated with the account. For example, the logic and/or rule(s) may define one or more default classes of service to be used for each type of mail piece when the class of service is not specifically defined in the return address indicium. In addition, the one or more classes of service may vary based on the size and/or weight of each type of mail piece. The method may further include determining (430) a return address indicium for a sender is on the mail piece, which may involve imaging the mail piece, locating the return address indicium in the image and converting the return address indicium into a machine usable form. This may include converting the bar-coded and human-readable portions of the return address indicium into digital representations of the information contained therein to be used to process the mail piece to which the return address indicium is attached. For example, the imaging, locating and converting may be performed using automated postal processing equipment including, but not limited to: automatic mail sorting/extraction equipment, Automated Package Processing System (“APPS”), and the like.

In FIG. 4, the method further may include determining (440) an account identified by an account number in the bar-coded portion of the return address indicium is valid, is associated with the sender identified in the return address indicium, and has a sufficient balance to pay the cost of delivering the mail piece. For example, the account number may be used to access a database of accounts and the sender information associated with the account number in the database may be compared with the sender information read from the return address indicium to ensure they match. The method may further still include deducting (450) the delivery cost from the balance in the account of the sender and associating a delivery cost paid indication with the mail piece. For example, associating the delivery cost paid indication with the mail piece may include printing the delivery cost paid indication directly on the mail piece and/or setting a flag in a record associated with the return address indicium in the database. Printing directly on the mail piece may be accomplished by printing the delivery cost paid indication directly over the return address indicium and/or any where else on the mail piece. Printing over the return address indicium may cause the return address indicium to no longer be readable and/or reused, which may provide an additional measure of security to prevent duplication and counterfeiting. The method may further include routing (460) the mail piece for delivery to the addressee, for example, the mail sorting/processing equipment may route the mail piece for delivery to the addressee.

Conversely, if the sender information associated with the account number in the database does not match the sender information read from the return address indicium and/or the account does not have a large enough balance to pay the cost for delivering the mail piece, the mail sorting/processing equipment may route the mail piece for return to the sender.

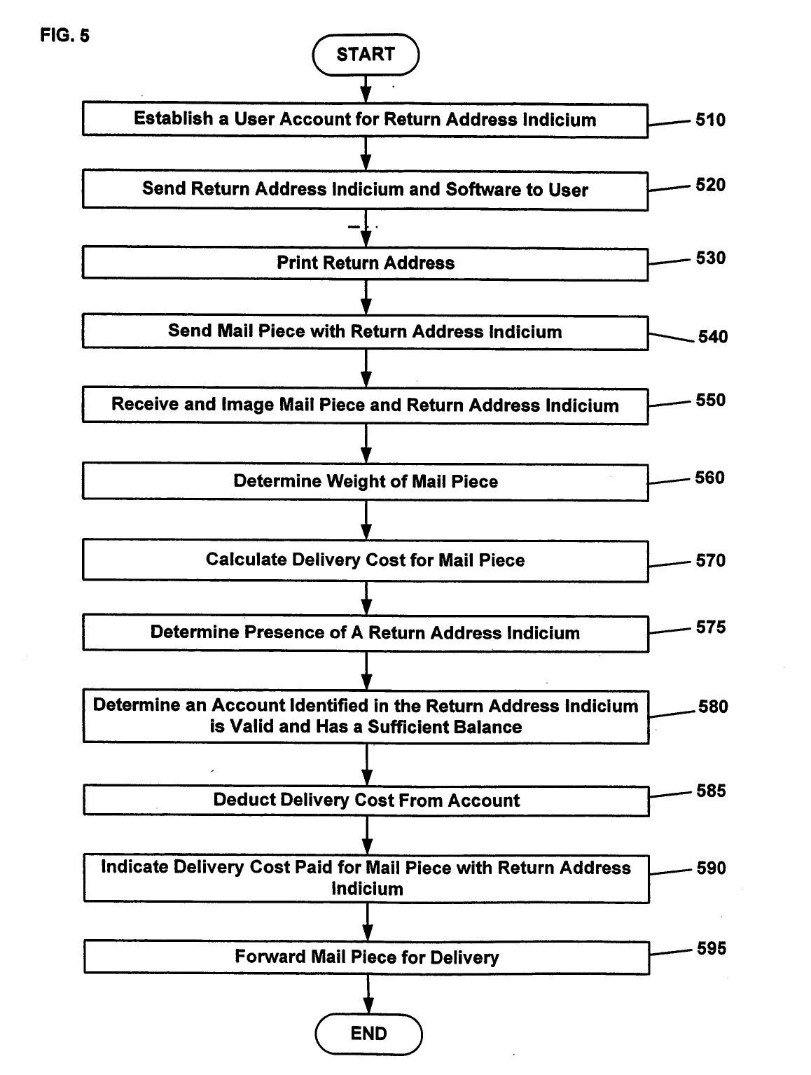

FIG. 5 is a flow diagram of an overall method for using a return address postal indicium, in accordance with an embodiment of the present invention. In FIG. 5, method may include a one-time, initial event of establishing (510) an account for one or more owners/users/senders at a sender address may be established at a return address indicium service provider, for example, the USPS, and an initial amount of funding may be provided to create a balance in the account. The account may be set up to be automatically replenished when the balance in the account falls below a certain level, for example, by automatically charging a credit card, debit card, debiting a checking account, debiting a savings account, etc. The account may also be set up to be replenished by notifying the account owner that the balance in the account has fallen below a pre-defined/pre-determined level and a new infusion of funds must be initiated by the account owner, for example, by charging a credit card and/or a debit card, writing a check or authorizing a direct withdrawal from a checking account and/or a savings account, etc. In addition, as part of the initial setup of the account, a list of valid sender names associated with the sender address may be associated with the account.

In addition, in FIG. 5, since one or more senders names may be associated with the same address, the method also may include another one-time, initial event of sending (520) one or more general electronic (i.e., digital) return address indicium to the user(s)/owner(s) of the account for printing as they are needed. A broken and dotted line is provided in FIG. 5, between (520) and (530), as well as in other figures to show a separation between the one-time, initial events and the rest of the method. As the user(s)/owner(s) print (530) each return address indicium, in addition to the account number, a unique serial number may be associated with and printed in the return address indicium, for example, in the bar-coded portion. This serial number may be used to detect and prevent duplication and/or counterfeiting of the return address indicium by keeping track of when each return address indicium appears in the mail stream using the serial number. Likewise, information specific to the mail piece for which the return address indicium is being printed also may be included in the bar-coded portion of the return address indicium. For example, this information may be entered by the owner(s) prior to printing of the return address indicium. If more than one owner/user/sender is associated with the account the serial numbers may be sequential and unique to the account and/or separately sequential and unique to each owner/user/sender. The serial numbers printed may be saved in a database associated with the account for later use when a mail piece with a return address indicium affixed thereto is sent (540) to an addressee through the delivery service provider.

Alternatively, the return address indicium service provider (e.g., the USPS) may print a number of return address indicium for the account, which may include the account number and may or may not include unique serial numbers. Likewise, the return address indicium may or may not include information on which type of mail piece they are to be attached. For example, the USPS may print a page of return address indicium for first class letters and print an identifier on the top of the page and/or on each label. Since both the return address indicium service provider and the owner/user/sender may print return address indicium, different serial number sequences may be used to prevent duplication and/or out of order serial numbers. For example, serial numbers printed by the return address indicium service provider may start with a unique code, for example, “USPS”, followed by the sequential numbers. The serial numbers printed by the return address indicium service provider used also may be recorded directly in the database associated with the account for later use when a mail piece containing a return address indicium may be sent (540) through the delivery service provider.

In FIG. 5, the method may include receiving (550) the mail piece with the return address indicium at the delivery service provider and an image of the mail piece may be taken. As described in more detail in relation to FIG. 4, in FIG. 5, the method may include determining (560) a weight for a mail piece; calculating (570) a delivery cost for the mail piece to an addressee identified on the mail piece; determining (575) a return address indicium for a sender is on the mail piece; and determining (580) an account is associated with the sender from the return address indicium. The method may also include deducting (585) the delivery cost from the account of the sender; associating (590) a delivery cost paid indication with the mail piece; and forwarding (595) the mail piece for delivery to the addressee.

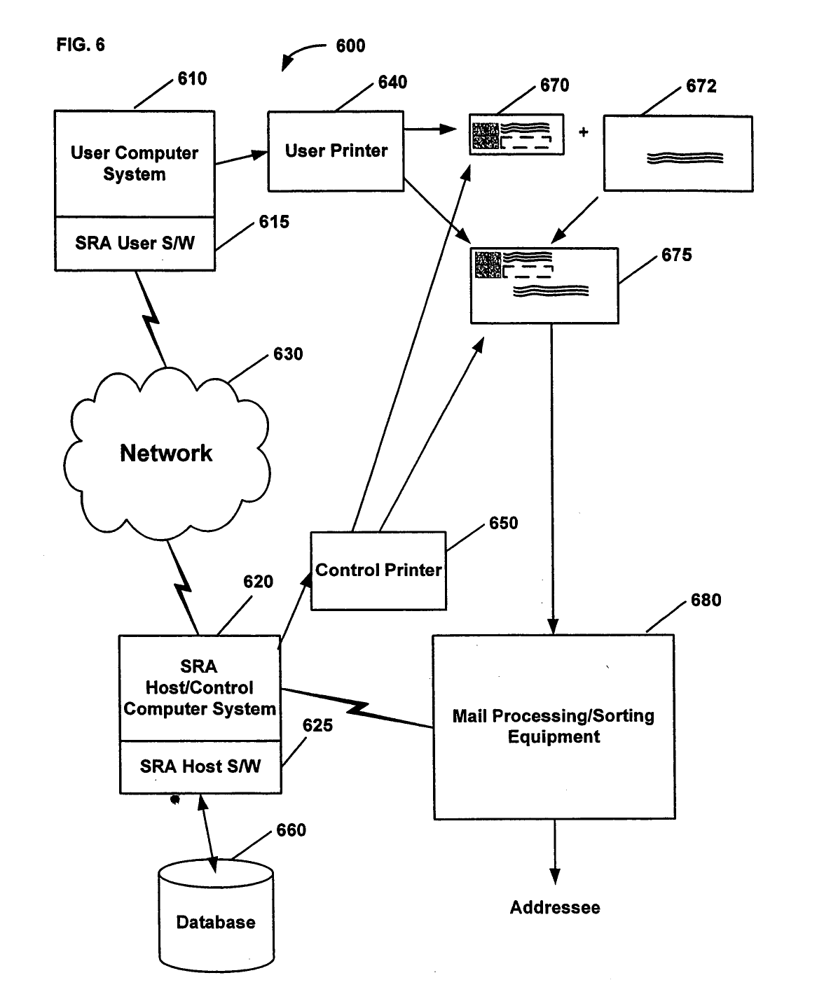

FIG. 6 is a block diagram of a system to print return address postal indicia, in accordance with another embodiment of the present invention. In FIG. 6, a return address postal indicia system 600 may include a user computer system 610, which may include a sender return address (“SRA”) user software component 615, and may be in communication with a sender return address control computer 620, which may include a sender return address host/control software component 625, through a network 630. Network 630 may be any communication network such as, for example, a local area network, a wide area network, the Internet, a landline telephone network, a wireless telephone network, etc. User computer system 610 may include, but are is not limited to, a personal computer system, for example, a system based on any of XXX86, Pentium, Pentium-like, AMD, Athlon, Motorola, and/or the like processors. User computer system 610 also may include one or more cache memories, an amount of random access memory (“RAM”), a mass storage device (e.g., hard disk, etc.) a monitor, a keyboard, etc. Sender return address user software component 615 may be provided on a machine-readable medium and/or downloaded from host/control computer system 620 to user computer system 610, for example, to the mass storage device. Sender return address user software component 615 may include a print driver for the return address indicium. User computer system 610 may be in communication with a user printer 640 to print return address indicia.

In FIG. 6, sender return address host software component 625 may control the downloading of sender return address user software component 615 to user computer system 610 and/or printing of sender return address indicia by user computer system 610 and/or at a host/control printer 650 that may be in communication with host/control computer system 620 as described above in relation to FIG. 5. In FIG. 6, host/control computer system 620 may include a personal computer similar to user computer system 610 as well as any other sufficiently capable computer including, but not limited to, a server, a workstation, etc. Host/control computer system 620 and/or sender return address host/control software component 625 also may be in communication with a data base 660 in which information related to the user accounts and/or printed return address indicia may be stored. Data base 660 may be implemented as a data base file on a host mass storage device that may be directly used by sender return address host/control software component 625 and/or in a separate data base system that may be in communication with sender return address host/control software component 625.

In FIG. 6, both user printer 640 and host/control computer printer 650 may print a return address indicium on a label 670 that may be affixed to a letter 672 and/or may print the return address indicium directly on a mail piece 675. Regardless of how the return address indicium is applied to mail piece 675, after the return address indicium is applied the mail piece 675 may be placed in the delivery system and ultimately processed through a mail processing/sorting equipment 680. Mail processing/sorting equipment 680 may be located at one of many regional mail processing facilities and/or at a main facility where host/control computer 620 also may be located. Mail processing/sorting equipment 680 may sort, weigh and image mail piece 675 and the return address indicium affixed thereto and obtain the necessary user account information, for example, a user account number, from the return address indicium. The account number may be used to access the appropriate user account, determine whether there is a sufficient balance in the account to pay for the delivery cost for mail piece 675, and deduct the delivery cost from the account. In addition, if a serial number is associated with the return address indicium, the fact that it has now been used (i.e., cancelled) may be recorded by sender return address host software component 625 in the user account, which, for example, may be stored in data base 660.

Alternatively, in FIG. 6, rather than storing a general sender return address indicium at user computer system 610, to generate a sender return address indicium, a user may use a browser and/or other program to log on to a web site hosted by host/control computer 620 using a user authentication/certification process. The user may enter information about a mail piece to print a return address indicium for that mail piece. For example, the information may include the type of mailing (e.g., letter, package, etc.) and/or class of service (e.g., first, second, etc.). However, if the class of service is not predefined in the return address indicium, it may be determined based at least on the type of mail piece and logic and/or one or more rules associated with the account. For example, the logic and/or rule(s) may define one or more default classes of service to be used for each type of mail piece when the class of service is not specifically defined in the return address indicium. In addition, the one or more classes of service may vary based on the size and/or weight of each type of mail piece. As described above, the mail piece specific information may be printed in the bar-coded portion and/or the human-readable portion of the return address indicium. The information supplied by the user may be stored at host/control computer 620 for later use when mail piece 675 with the return address indicium is placed in the mail delivery system and received and imaged at mail processing/sorting equipment 680. When mail piece 675 is received at mail processing/sorting equipment 680 mail piece 675 may be imaged and weighed, the type and class of service for mail piece 675 may be determined, and the cost for delivery may be determined. The user's account may be checked to determine that there is a sufficient balance in the account to pay the delivery cost, the delivery cost may be deducted from the balance in the account and mail piece 675 may be sorted for delivery. If the user's account does not have a sufficient balance and does not have an automatic replenishment option, mail piece 675 may be sorted for later reprocessing/delivery and/or returned to the sender for insufficient postage.

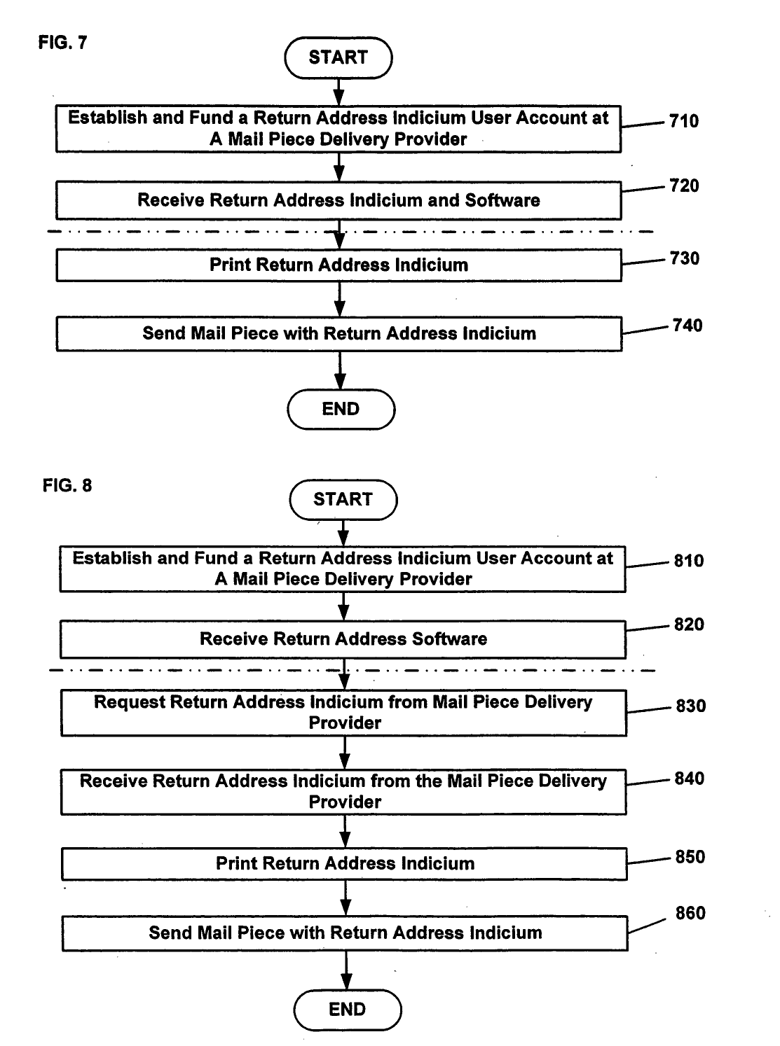

FIG. 7 is a flow diagram of a method for printing and using a return address postal indicium, in accordance with an embodiment of the present invention. In FIG. 7, the method may include a one-time, initial event of establishing (710) an account for one or more owners/users/senders at a return address indicium service provider, for example, the USPS and/or private delivery service (i.e. Fed Ex, UPS and the like), and providing an initial amount of funding to create a balance in the account. The account may be set up to be automatically replenished when the balance in the account falls below a certain level, for example, by automatically charging a credit card, debit card, debiting a checking account, debiting a savings account, etc. The account may also be set up to be replenished by notifying the account owner that the balance in the account has fallen below a pre-defined/pre-determined level and a new infusion of funds must be initiated by the account owner, for example, by charging a credit card and/or a debit card, writing a check or authorizing a direct withdrawal from a checking account and/or a savings account, etc. In addition, as part of the initial establishing (710) of the account, a list of valid sender names associated with the sender address may be associated with the account. As described above in relation to FIG. 6, whoever establishes (710) the account may do so electronically over the web, in person, and/or over the phone at the return address indicium provider.

In addition, in FIG. 7, since one or more senders names may be associated with the same address, the method also may include another one-time, initial event of receiving (720) one or more general electronic (i.e., digital) return address indicium to the user(s)/owner(s) of the account for printing as they are needed. The method also may include each user(s)/owner(s) printing (730) their own return address indicium, which, in addition to the account number, may include a unique serial number associated with and printed in the return address indicium, for example, in the bar-coded portion. In general, the account and serial numbers will not be printed in a human-readable form. This serial number may be used to detect and prevent duplication and/or counterfeiting of the return address indicium by keeping track of when each return address indicium appears in the mail stream using the serial number. Likewise, information specific to the mail piece for which the return address indicium is being printed also may be included in the bar-coded portion of the return address indicium. For example, this information, which may include, but is not limited to, class of service, type of mail piece, a weight at mailing, etc. may be entered by the owner(s) prior to printing of the return address indicium. If more than one owner/user/sender is associated with the account the serial numbers may be assigned sequentially and uniquely at to the account level and/or separately sequentially and uniquely to each owner/user/sender. The serial numbers printed may be saved in at least one database associated with the account for later use when a mail piece to which a return address indicium with the serial number has been affixed is sent (740) to a recipient through the delivery service provider. The data base may be local to the owner/user/sender, e.g., at user computer system 610 and/or remote from the owner/user/sender, e.g., in data base 660 at host/control computer system 620. If the return address indicium is printed and serialized at user computer system 610, a subsequent transmission of a data base record for the indicium host/control computer system 620 and data base 660 may be initiated. The data is needed by host/control computer system 620, if duplication and/or counterfeit detection is to be performed.

Alternatively, the return address indicium service provider (e.g., the USPS and/or other delivery service) may print a number of return address indicium for the account, which may include the account number and may or may not include unique serial numbers. Likewise, the return address indicium may or may not include information on which type of mail piece they are to be attached. For example, the USPS may print a page of return address indicium for first class letters and print an identifier on the top of the page and/or on each label as a reference for the owner/user/sender. Since both the return address indicium service provider and the owner/user/sender may print return address indicium, different serial number sequences may be used to prevent duplication and/or out of order serial numbers. For example, serial numbers printed by the return address indicium service provider may start with a unique code, for example, “USPS”, followed by the sequential numbers. The serial numbers printed by the return address indicium service provider used also may be recorded directly in the database associated with the account for later use in the method when a mail piece to which the return address indicium has been affixed is sent (740) to the recipient through the delivery service provider.

FIG. 8 is a flow diagram of a method for printing and using a return address postal indicium, in accordance with another embodiment of the present invention. As in FIG. 7, in FIG. 8, the method may include a one-time, initial event of establishing (810) an account for one or more owners/users/senders at a return address indicium service provider, for example, the USPS, and providing an initial amount of funding to create a balance in the account and replenishment of the account may be setup as described previously. The method also may include another one-time event associated with the initial setup of the account of receiving (820) a return address indicium software application for printing return address indicium as they are needed. The method also may include requesting (830) a return address indicium from the mail piece delivery service provider and receiving (840) the return address indicium from the mail piece delivery service provider in response to the request (830). The request (830) may include specific information on the mail piece (e.g., type, class of service, characteristics, etc.) to which the return address indicium is to be affixed. The method may include printing (850) each return address indicium with the account number with or without a unique serial number, as described previously, for example, in the bar-coded portion. The serial number(s) printed may be recorded in a database associated with the account for later use in the method when a mail piece to which the return address indicium has been affixed may be sent (860) through the mail delivery service provider.

What is claimed is:

1. A method comprising:
determining a weight for a mail piece;
calculating a delivery cost for the mail piece to an addressee identified on the mail piece;
determining a return address indicium for a sender is on the mail piece, the return address indicium including a bar-code;
determining an account is associated with the sender from the return address indicium by
taking an image of the return address indicium from the mail piece;
reading the image to obtain an account number from the bar-code;
determining the account number is for the account associated with the sender; and
determining a balance in the account is sufficient to pay the calculated delivery cost;
deducting the delivery cost from the account of the sender;
associating a delivery cost paid indication with the mail piece; and
forwarding the mail piece for delivery to the addressee.

2. The method of claim 1 further comprising:
automatically replenishing the account of the sender, if a balance in the account is below a pre-defined amount.

3. The method of claim 1 further comprising:
establishing the account of the sender; and
providing the return address indicium to the sender.

4. The method of claim 3 wherein the providing the return address indicium to the sender comprises:
providing the return address indicium as an electronic indicium for printing directly on the mail piece or on a pre-printed label for application to the mail piece.

5. The method of claim 1 wherein the calculating the delivery cost for the mail piece comprises:
calculating the delivery cost based on the weight of the mail piece and a class of service for a type of the mail piece.

6. The method of claim 5 wherein the class of service for the type of the mail piece is determined by one of:
reading the class of service from the return address indicium, if the class of service is specified in the return address indicium; and
selecting the class of service based at least on the type of mail piece and at least one rule associated with the account.

7. The method of claim 1 wherein the determining an account is associated with the sender from the return address indicium comprises:
taking an image of the return address indicium from the mail piece;
reading the image to obtain an account number;
determining the account number is for the account associated with the sender; and
determining a balance in the account is sufficient to pay the calculated delivery cost.

8. The method of claim 7 wherein the associating a delivery cost paid indication with the mail piece comprises:
printing the delivery cost paid indication on the mail piece.

9. A machine-readable medium having stored thereon executable instructions for performing a method comprising:
determining a weight for a mail piece;
calculating a delivery cost for the mail piece to an addressee identified on the mail piece;
determining a return address indicium for a sender is on the mail piece;
determining an account is associated with the sender from the return address indicium;
deducting the delivery cost from the account of the sender;
associating a delivery cost paid indication with the mail piece; and
forwarding the mail piece for delivery to the addressee.

10. The machine-readable medium of claim 9 further comprising:
automatically replenishing the account of the sender, if a balance in the account is below a pre-defined amount.

11. The machine-readable medium of claim 9 further comprising:

11. The machine-readable medium of claim 9 further comprising:
establishing the account of the sender; and
providing the return address indicium to the sender.

12. The machine-readable medium of claim 11 wherein the providing the return address indicium to the sender comprises:
providing the return address indicium as an electronic indicium for printing directly on the mail piece or on a pre-printed label for application to the mail piece.

13. The machine-readable medium of claim 9 wherein the calculating the delivery cost for the mail piece comprises:
calculating the delivery cost based on the weight of the mail piece and a class of service for a type of the mail piece.

14. The machine-readable medium of claim 13 wherein the class of service for the type of the mail piece is determined by one of:
reading the class of service from the return address indicium, if the class of service is specified in the return address indicium; and
selecting the class of service based at least on the type of mail piece and at least one rule associated with the account.

15. The machine-readable medium of claim 9 wherein the determining an account is associated with the sender from the return address indicium comprises:
taking an image of the return address indicium from the mail piece;
reading the image to obtain an account number;
determining the account number is for the account associated with the sender; and
determining a balance in the account is sufficient to pay the calculated delivery cost.

16. The machine-readable medium of claim 15 wherein the associating a delivery cost paid indication with the mail piece comprises:
printing the delivery cost paid indication on the mail piece.

17. A return address indicium product comprising:
a human-readable portion of a return address indicium product to represent a return address of a sender of an item; and
a bar-coded portion of the return address indicium product to represent the return address of the sender of the item, the bar-coded portion including account information associated with the sender to be used to pay the cost for delivering the item to which the return address indicium is attached.

18. The return address indicium product of claim 17 wherein the bar-coded portion comprises:
a datamatrix representation of the human-readable portion.

19. The return address indicium product of claim 17 wherein the bar-coded portion is encrypted.

20. The return address indicium product of claim 17 wherein the account information comprises:
an account number for an account associated with the sender from which payment for the cost for delivering the item is deducted.

21. A method comprising:
requesting a return address indicium associated with an account of a sender for paying delivery charges for a mail piece;
receiving the return address indicium;
printing the return address indicium; and
sending the mail piece to which the return address indicium is affixed to a recipient through a delivery service.

22. The method of claim 21 further comprising:
establishing the account of the sender, if the account is not yet established; and
receiving machine-readable instructions to request and print the return address indicium once after the account is established.

23. The method of claim 21 wherein requesting the return address indicium comprises:
requesting a basic return address indicium including an account number for the account of the sender.

24. The method of claim 21 wherein requesting the return address indicium comprises:
requesting a detailed return address indicium including an account number for the account of the sender and at least one of a type of the mail piece and a class of service for the mail piece.

25. The method of claim 21 wherein printing the return address indicium comprises:
printing a human-readable return address for the sender; and
printing a bar-coded portion to include an account number for the account of the sender.

26. A machine-readable medium having stored thereon executable instructions for performing a method comprising:
requesting a return address indicium associated with an account of a sender for paying delivery charges for a mail piece;
receiving the return address indicium; and
printing the return address indicium to include
a human-readable return address for the sender; and
a bar-coded portion to include an account number for the account of the sender.

27. The machine-readable medium of claim 26 wherein requesting the return address indicium comprises:
sending a request for a basic return address indicium including an account number for the account of the sender.

28. The machine-readable medium of claim 26 wherein requesting the return address indicium comprises:
sending a request for a detailed return address indicium including an account number for the account of the sender and at least one of a type of the mail piece and a class of service for the mail piece.

29. The machine-readable medium of claim 26 wherein receiving the return address indicium comprises at least one of:
receiving a first return address indicium including an account number for the account of the sender; and
receiving a second return address indicium including an account number for the account of the sender and at least one of a type of the mail piece and a class of service for the mail piece.
